(19) United States
(12) Patent Application Publication
(10) Pub. No.: US 2017/0238284 A1
(43) Pub. Date: Aug. 17, 2017

(54) Multi-Carrier Operation for Narrowband Internet of Things

(71) Applicant: MEDIATEK INC., Hsinchu (TW)

(72) Inventors: Li-Chuan Tseng, Hsinchu City (TW); Per Johan Mikael Johansson, Kungsangen (SE); Yih-Shen Chen, Hsinchu County (TW)

(21) Appl. No.: 15/423,982

(22) Filed: Feb. 3, 2017

Related U.S. Application Data
(60) Provisional application No. 62/291,596, filed on Feb. 5, 2016.

(51) Int. Cl. H04W 72/04; H04W 24/08; H04W 76/02; H04W 74/08

(52) U.S. Cl. CPC H04W 72/042; H04W 72/0453; H04W 74/0833; H04W 24/08; H04W 76/02; H04L 67/12

(57) ABSTRACT

A novel and efficient multi-carrier operation mechanism is proposed to maintain the capacity and reliability for NB-IOT systems. First, the functional separation on anchor NB-IOT carrier and data NB-IOT carriers is defined. Transportation of system broadcast information, including synchronization signal (NB-PSS/NB-SSS) and NB-MIB (NB-PBCH) and paging are on anchor carrier, RACH procedure and Data transmission and reception are on data carrier. Second, UE switching between anchor and data carriers. UE on anchor carrier switches to data carrier via paging, RRC signaling or cross-carrier scheduling. On the other hand, UE on data carrier switches back to anchor carrier after transmission or reception complete (right-after or after time-out).

### CROSS REFERENCE TO RELATED APPLICATIONS

This application claims priority under 35 U.S.C. §119 from U.S. Provisional Application No. 62/291,596 entitled “Multi-carrier Operation for NB-IOT,” filed on Feb. 5, 2016, the subject matter of which is incorporated herein by reference.

### TECHNICAL FIELD

The disclosed embodiments relate generally to Narrowband Internet of Things (NB-IOT), and, more particularly, to multicarrier operation for NB-IOT.

### BACKGROUND

In 3GPP Long-Term Evolution (LTE) networks, an evolved universal terrestrial radio access network (E-UTRAN) includes a plurality of base stations, e.g., evolved Node-Bs (eNodeBs) communicating with a plurality of mobile stations referred as user equipment (UEs). Orthogonal Frequency Division Multiple Access (OFDMA) has been selected for LTE downlink (DL) radio access scheme due to its robustness to multipath fading, higher spectral efficiency, and bandwidth scalability. Multiple access in the downlink is achieved by assigning different sub-bands (i.e., groups of subcarriers, denoted as resource blocks (RBs)) of the system bandwidth to individual users based on their existing channel condition.

Narrowband Internet of Things (NB-IOT) is a Low Power Wide Area Network (LPWAN) radio technology standard that has been developed to enable a wide range of devices and services to be connected using cellular telecommunications bands. 3GPP has approved the working item of NB-IOT, aiming at supporting a large number of low-cost, low-power IOT devices. Considering the factors including traffic pattern, UE density, and battery life requirements, many existing LTE control plane mechanisms need modifications for NB-IOT.

Multicarrier operation has been agreed where a UE may camp on one NB-IOT carrier and then transmitting and receiving data on another carrier. To justify the need of multicarrier operation, some major differences between NB-IOT devices and current LTE UEs are considered. First, much narrower bandwidth (200 KHz), meaning that system broadcast information and common control signaling may occupy a significant portion of each carrier. Second, traffic patter with infrequent and small data, implying that most of the time a NB-IOT UE is monitoring the control channel instead of transmitting or receiving data. Third, a larger number (>50,000) NB-IOT UEs in a cell is to be supported, which means that offloading UEs to different carriers may be needed. In summary, the narrower bandwidth and large number of NB-IOT UEs result in the inefficiency of the current LTE systems where common control information is transmitted on each carrier.

To mitigate signaling overheads under multicarrier operation, it is proposed to transport system broadcast information such as synchronization signals (NB-PSS/NB-SSS) and NB-MIB (NB-PBCH) only on a specific carrier, referred to as the “anchor NB-IOT carrier”. A UE must camp on the anchor carrier to receive required information when waking up. It is however desirable to allow UE camping and sending or receiving data on different carriers. A solution of such multi-carrier operation mechanism to improve the capacity and reliability for NB-IOT devices in LTE systems is sought.

### SUMMARY

A novel and efficient multi-carrier operation mechanism is proposed to maintain the capacity and reliability for NB-IOT systems. First, the functional separation on anchor NB-IOT carrier and data NB-IOT carriers is defined. Transportation of system broadcast information, including synchronization signal (NB-PSS/NB-SSS) and NB-MIB (NB-PBCH) and paging are on anchor carrier, RACH procedure and Data transmission and reception are on data carrier. Second, UE switching between anchor and data carriers. UE on anchor carrier switches to data carrier via paging, RRC signaling or cross-carrier scheduling. On the other hand, UE on data carrier switches back to anchor carrier after transmission or reception complete (right-after or after time-out).

In one embodiment, a UE receives control and reference information from a base station over an anchor carrier. The UE supports multicarrier operation over the anchor carrier and a plurality of non-anchor carriers. The UE selects a data carrier from the plurality of non-anchor carriers and switches to the data carrier upon receiving a paging message. The UE performs a random-access channel (RACH) procedure with a base station over the selected data carrier. The UE establishes a radio resource control (RRC) connection and performing a data exchange with the base station over the selected data carrier.

In another embodiment, a UE receives control and reference information from a base station over an anchor carrier. The UE supports multicarrier operation over the anchor carrier and a plurality of non-anchor carriers. The UE monitors a physical downlink control channel (PDCCH) on the anchor carrier and receives downlink control information (DCI). The UE switches to a selected data carrier from the plurality of non-anchor carriers based on the DCI received on the anchor carrier. Finally, the UE establishes a radio resource control (RRC) connection and performs a data exchange with the base station over the selected data carrier.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a mobile communication network with narrowband Internet of Things (NB-IOT) devices supporting multicarrier operation in accordance with one novel aspect.

FIG. 2 illustrates simplified block diagrams of a base station and a user equipment in accordance with embodiments of the present invention.

FIG. 3 illustrates one example of a finite state machine of UE switching between different carriers in a multicarrier operation.

FIG. 4 illustrates one embodiment of autonomously selects data carrier for RACH procedure by NB-IOT UE capable of multicarrier operation.

FIG. 5 illustrates one embodiment of data carrier assignment via paging or RRC signaling for NB-IOT UE capable of multicarrier operation.

FIG. 6 is a flow chart of a method of multicarrier operation from NB-IOT UE perspective in accordance with one novel aspect.

FIG. 7 is a flow chart of a method of multicarrier operation with cross-carrier scheduling in accordance with one novel aspect.

### DETAILED DESCRIPTION

Reference will now be made in detail to some embodiments of the invention, examples of which are illustrated in the accompanying drawings.

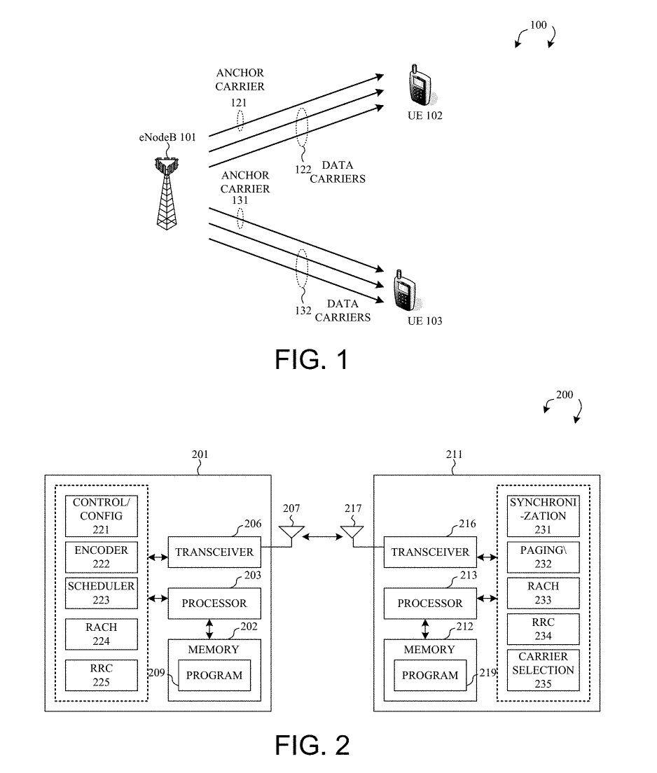

FIG. 1 illustrates a mobile communication network 100 with narrowband Internet of Things (NB-IOT) devices supporting multicarrier operation in accordance with one novel aspect. Mobile communication network 100 is an OFDM/OFDMA system comprising a base station eNodeB 101 and a plurality of user equipments including UE 102 and UE 103. In 3GPP LTE/LTE-A systems, operations could be divided to two radio resource control (RRC) states: RRC_CONNECTED and RRC_IDLE. In RRC_CONNECTED mode, a UE establishes a dedicated connection with the eNodeB. The UE is ensured to make seamless data transmission with the eNodeB when the UE is in RRC_CONNECTED mode. When there is a downlink packet to be sent from eNodeB to UE, each UE gets a downlink assignment, e.g., a set of radio resources in a physical downlink shared channel (PDSCH). When a UE needs to send a packet to eNodeB in the uplink, the UE gets a grant from the eNodeB that assigns a physical uplink shared channel (PUSCH) consisting of a set of uplink radio resources. The UE gets the downlink or uplink scheduling information from a physical downlink control channel (PDCCH) that is targeted specifically to that UE. Since radio resources and network capacity are limited, it is impossible to keep all UEs in RRC_CONNECTED mode. Inactive UEs are therefore released to RRC_IDLE mode. An idle UE can receive system information broadcasted from eNodeB.

In the example of FIG. 1, eNodeB 101, UE 102, and UE 103 are Narrowband Internet of Things (NB-IOT) devices. Coverage extension, UE complexity reduction, long battery lifetime, and backward compatibility are common objectives for IOT. In addition, NB-IOT aims to offer deployment flexibility allowing an operator to introduce NB-IOT using a small portion of its existing available spectrum. NB-IOT requires 180 KHz minimum system bandwidth for both downlink and uplink, respectively. An LTE operator can deploy NB-IOT inside an LTE carrier by allocating one of the physical resource blocks (PRBs) of 180 KHz to NB-IOT. An LTE operator also has the option of deploying NB-IOT in the guard band of the LTE carrier.

Specifically, in 3GPP LTE systems based on OFDMA downlink, the radio resource is partitioned into subframes, each of which is comprised of two slots and each slot has seven OFDMA symbols along time domain. Each OFDMA symbol further consists of a number of OFDMA subcarriers along frequency domain depending on the system bandwidth. The basic unit of the resource grid is called Resource Element (RE), which spans an OFDMA subcarrier over one OFDMA symbol. A physical resource block (PRB) occupies one slot and twelve subcarriers, while a PRB pair occupies two consecutive slots. The downlink of NB-IOT is based on OFDMA with the same 15 KHz subcarrier spacing as LTE. In essence, an NB-IOT carrier uses one LTE PRB in the frequency domain, i.e., twelve 15 KHz subcarriers for a total of 180 KHz. When NB-IOT is deployed inside an LTE carrier, the orthogonality between NB-IOT PRB and all other LTE PRBs is preserved in the downlink. Like the NB-IOT downlink, an uplink NB-IOT carrier uses a total system bandwidth of 180 KHz.

The narrower bandwidth and large number of NB-IOT UEs result in the inefficiency of the current LTE systems where common control information is transmitted on each carrier. Therefore, multicarrier operation of NB-IOT is supported. Under multicarrier operation, a UE may camp on one NB-IOT carrier and then transmitting and receiving data on another carrier. In the example of FIG. 1, UE 102 may camp on anchor carrier 121, and then perform data exchange with eNB 101 over one of the no-anchor data carriers 122. Similarly, UE 103 may camp on anchor carrier 131, and then perform data exchange with eNB 101 over one of the non-anchor data carriers 132.

Note that multicarrier operation is different from carrier aggregation. Under carrier aggregation, a number of separate LTE carriers are combined together for simultaneous data transmission, enabling higher date rate and overall capacity of the networks. For multicarrier operation, a UE switches between different NB-IOT carriers and operates one NB-IOT carrier at a time. To mitigate signaling overheads, it is proposed to transport system broadcast information such as synchronization signals (NB primary synchronization signal and NB secondary synchronization signal) (NB-PSS/NB-SSS) and NB-MIB (NB physical broadcast channel) (NB-PBCH) only on a specific carrier, referred to as the “anchor NB-IOT carrier”. A UE must camp on the anchor carrier to receive required information when waking up. However, it is an objective to allow UE camping on anchor carrier and sending or receiving data on different NB-IOT carriers.

In accordance with one novel aspect, the present invention addresses the following issues of multicarrier operation. First, the functional separation on anchor NB-IOT carrier and data NB-IOT carriers. Transportation of system broadcast information, including synchronization signal (NB-PSS/NB-SSS) and NB-MIB (NB-PBCH) on anchor carrier; Paging on anchor carrier; RACH procedure on data carrier; and Data transmission and reception on data carrier. Second, UE switching between anchor and data carriers. UE on anchor carrier switches to data carrier via paging, RRC signaling or cross-carrier scheduling. On the other hand, UE on data carrier switches back to anchor carrier right after transmission or reception complete (right-after or after time-out).

FIG. 2 illustrates simplified block diagrams of a base station 201 and a user equipment 211 in accordance with embodiments of the present invention. For base station 201, antenna 207 transmits and receives radio signals. RF transceiver module 206, coupled with the antenna, receives RF signals from the antenna, converts them to baseband signals and sends them to processor 203. RF transceiver 206 also converts received baseband signals from the processor, converts them to RF signals, and sends out to antenna 207. Processor 203 processes the received baseband signals and invokes different functional modules to perform features in base station 201. Memory 202 stores program instructions and data 209 to control the operations of the base station.

Similar configuration exists in UE 211 where antenna 217 transmits and receives RF signals. RF transceiver module 216, coupled with the antenna, receives RF signals from the antenna, converts them to baseband signals and sends them to processor 213. The RF transceiver 216 also converts received baseband signals from the processor, converts them to RF signals, and sends out to antenna 217. Processor 213 processes the received baseband signals and invokes different functional modules to perform features in UE 211. Memory 212 stores program instructions and data 219 to control the operations of the UE.

The base station 201 and UE 211 also include several functional modules and circuits to carry out some embodiments of the present invention. The different functional modules and circuits can be configured and implemented by software, firmware, hardware, or any combination thereof. The function modules and circuits, when executed by the processors 203 and 213 (e.g., via executing program codes 209 and 219), for example, allow base station 201 to encode and transmit downlink control information to UE 211, and allow UE 211 to receive and decode the downlink control information accordingly. In one example, base station 201 determines control and configuration information via control/config module 221 and modulates and encodes the information via encoder 222 to be broadcasted over paging or unicasted over RRC. Base station 201 also performs scheduling via scheduler 223 and sends dynamic scheduling over PDCCH. RACH module 224 is for performing random access with the UE and RRC module 225 is for establishing RRC connection with the UE. UE 211 performs synchronization with the base station via synchronization circuit 231 and then camp on an anchor carrier and then monitors paging via paging circuit 232. UE 211 performs RACH with the base station via RACH module 233 and establishes RRC connection with the base station via RRC module 234. Based on the control and reference information received from the base station, UE 211 also performs carrier selection and selects a non-anchor data carrier for RACH and data transmission to offload traffic from the anchor carrier. The non-anchor data carrier can be selected by UE autonomously, or by carrier assignment over paging or RRC signaling. Under cross-carrier scheduling, the UE monitors PDCCH over the anchor carrier and switches to non-anchor carrier for data transmission. The UE switches back to the anchor carrier upon the transmission is completed.

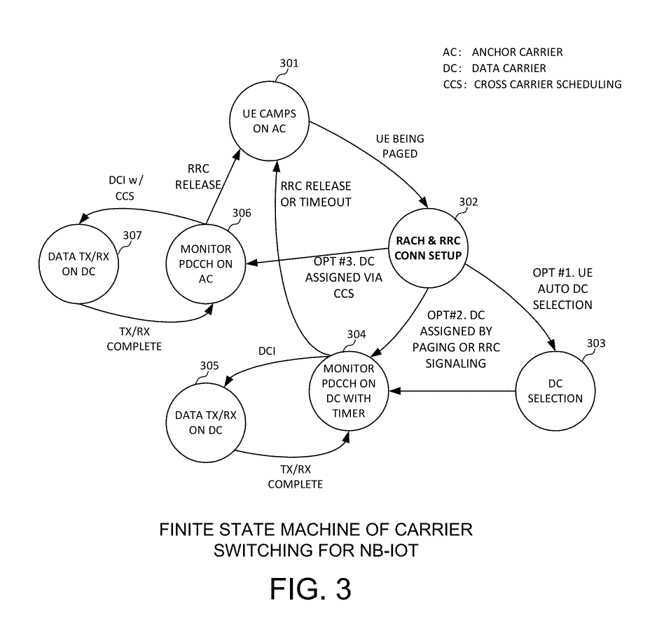

FIG. 3 illustrates one example of a finite state machine of UE switching between different carriers in a multicarrier operation. To mitigate signaling overheads, it is proposed to transport the system broadcast information, common control information, and unicast data, on different carriers. An anchor NB-IOT carrier and one or more data carriers are configured. System broadcast information including synchronization signal (NB-PSS/SSS) and NB-MIB (PBCH) are transmitted only on the anchor carrier. Notice that according to 3GPP RAN agreements, there will be one PBCH configured every 10 subframes. A large portion of radio resources will be occupied if such system broadcast information is to be transmitted on each NB-IOT carrier, which is however not necessary as long as all UEs camp on the anchor carrier. Since UE camps on anchor carrier and paging for a single UE is quite infrequent, a UE monitors paging occasions on anchor carrier, and therefore paging messages are also transmitted on the anchor carrier.

On the other hand, the carrier used for random access by a UE configured with additional PRB(s) depends on the adopted scenario. For a UE with CP solution, random access procedure should be performed on the additional PRB since the small packet is carried right after the RACH procedure. For a UE with UP solution, random access may also be performed on the anchor carrier, but cross-carrier scheduling needs to be supported to indicate the UE to transmit data on the additional carrier. With such functional separation, significant signaling overhead can be reduced.

In the example of FIG. 3, the UE knows which carrier to monitor based on the finite state machine. Initially, the UE camps on the anchor carrier (301). UE performs synchronization with the base station over the anchor carrier, and monitors paging occasions over the anchor carrier. Upon being paged, the UE performs RACH procedure and RRC connection set up (302). In a first option (OPTION #1), the UE autonomously selects a data carrier (303). In a second option (OPTION #2), the UE is assigned for a data carrier by paging or RRC signaling. The UE switches to the selected or the assigned data carrier. The UE then monitors PDCCH on the selected or the assigned data carrier with timer (304). The UE also performs data transmission and reception on the data carrier (305) and goes back to 304 upon TX/RX completion. Upon RRC release or timeout, the UE switches back to the anchor carrier (301). In a third option (OPTION #3), the UE is assigned for a data carrier by cross carrier scheduling. The UE monitors PDCCH on the anchor carrier (306), and switches to data carrier for data transmission and reception (307) as indicated by the downlink control information (DCI) carried on PDCCH. The UE switches back to the anchor carrier right after data transmission or reception indicated by the DCI.

In one advantageous aspect, after UE being paged over the anchor carrier in state 301, the RACH procedure in state 302 can be performed over a data carrier, which can be autonomously selected by the UE, assigned by paging or RRC signaling. The RACH procedure involves four (4) steps. In a first step, UE sends a RACH preamble to eNodeB over allocated RACH resources. In a second step, eNodeB sends a Random-Access Response (RAR) back to UE. In a third step, UE sends a Layer 2/Layer 3 Message that conveys the actual random access procedure message, such as an RRC connection request. In a fourth step, eNodeB sends a contention resolution message. After the RACH procedure, the UE can send a connection setup complete message with actual uplink data. In one embodiment, the RACH PRB resource is based on the parameters received by the UE from the paging message. In another embodiment, the RACH PRB resource is selected by the UE based on anchor carrier configuration information and distribution information broadcasted by the network. By performing RACH over the data carrier, more offloading from the anchor carrier can be achieved.

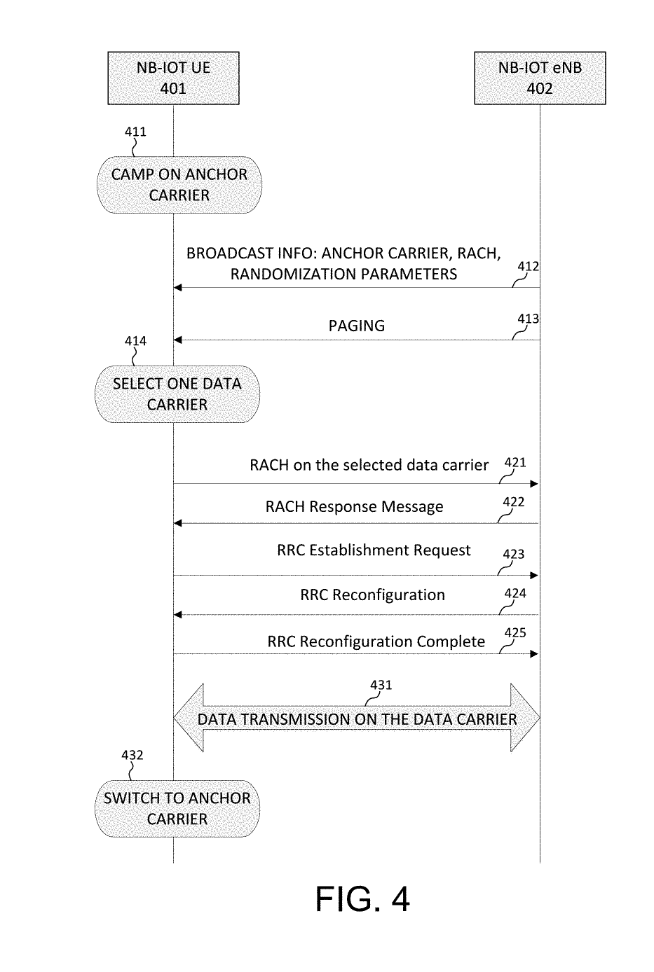

FIG. 4 illustrates one embodiment of autonomously selects data carrier for RACH procedure by NB-IOT UE capable of multicarrier operation. In step 411, the NB-IOT UE 401 camps on an anchor carrier served by the NB IOT eNB 402, which supports the anchor carrier and a plurality of non-anchor data carriers. UE 401 performs synchronization with eNB 402. In general, control and reference information needed for UE camping are available on the anchor carrier. The control and reference information includes synchronization signals (NB-PSS/NB-SSS), pilot or reference signals, MIB (NB-PBCH) and SIBs needed for camping. In step 412, the UE receives broadcasted information from the eNB over the anchor carrier. The broadcasted information includes anchor carrier information, RACH configuration information, and other randomization parameters. The anchor carrier may broadcast a plurality of RACH configurations of data carriers. In step 413, the UE monitors paging occasions and receives paging over the anchor carrier. Upon being paged, in step 414, the UE autonomously selects one data carrier from the plurality of data carriers.

The information needed by the UE to find data carriers which may be eligible for selection is provided on the anchor carrier where the UE camps or is served. The information about a data carrier may include frequency information, a TDM pattern, and/or information about common channels applicable for the data carrier, e.g., a downlink control channel, an uplink access channel, e.g., RACH. The UE selects data carrier by one or more of the following methods. First, the UE selects a data carrier among eligible data carriers, randomly or pseudo-randomly by one or more of the following methods. In one example, UE draws a random number and uses it in a comparison towards a threshold, where the outcome of the comparison determines the selection. The threshold value may be fixed in specifications or signaled to the UE, and the threshold value and/or the final number value used in the comparison may be computed by the UE, e.g. based on the number of data carriers eligible for selection. In another example, UE computes a pseudo-random number and uses it in a comparison towards a threshold, where the outcome of the comparison determines the selection. The pseudo-random number may be based on a Modulo operation of a known identifier, e.g. a UE-ID. The threshold value may be fixed in specifications or signaled to the UE, and the threshold value and/or the final number value used in the comparison may be computed by the UE, e.g. based on the number of data carriers eligible for selection. Second, the UE determines if a data carrier is eligible, based on eligibility information that is applicable for the data carrier. The eligibility information may be provided on the anchor carrier and may be one of Service identity, network slice identity, QoS class identifier. Third, the UE determines if a data carrier is eligible, based on radio coverage related information that is applicable for the data carrier. The radio coverage related information may be provided on the anchor carrier. The UE compares the provided information towards radio measurements that the UE performs, e.g., the UE determines its required coverage class based on measurement and compares this to supported coverage class information for the data carrier.

Upon data carrier selection, UE that is currently on the anchor carrier switches to the selected data carrier after receiving the paging message, and performs RACH procedure and reads PDCCH on the selected data carrier. In step 421, the UE performs RACH procedure by sending a RACH preamble to the eNB. In step 422, the UE receives a random-access response (RAR) message from the eNB. In step 423, the UE sends an RRC establishment request to the eNB. In step 424, the UE receives an RRC reconfiguration message from the eNB. In step 425, the UE sends an RRC reconfiguration complete to the eNB. In step 431, the UE performs data transmission and reception on the data carrier. A timer is started after each data transmission or reception. In step 432, the UE switches back to the anchor carrier upon timeout.

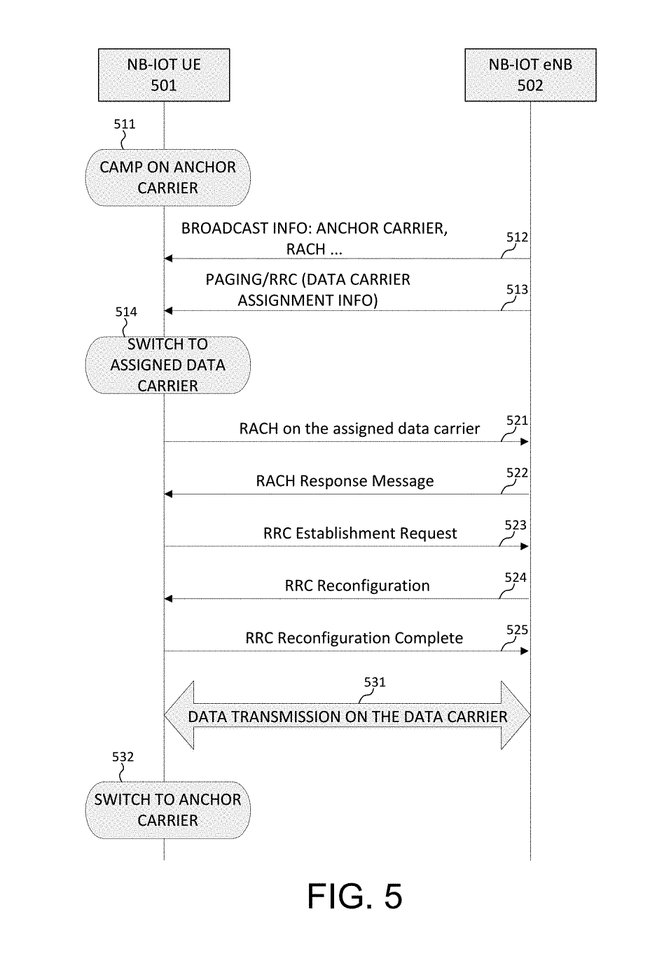

FIG. 5 illustrates one embodiment of data carrier assignment via paging or RRC signaling for NB-IOT UE capable of multicarrier operation. In step 511, the NB-IOT UE 501 camps on an anchor carrier served by the NB IOT eNB 502, which supports the anchor carrier and a plurality of non-anchor data carriers. UE 501 performs synchronization with eNB 502 over the anchor carrier. In general, control and reference information needed for UE camping are available on the anchor carrier. The control and reference information includes synchronization signals (NB-PSS/NB-SSS), pilot or reference signals, MIB (NB-PBCH) and SIBs need for camping. In step 512, the UE receives broadcasted information from the eNB over the anchor carrier. The broadcasted information includes anchor carrier information, RACH configuration information, and other randomization parameters. The anchor carrier may broadcast a plurality of RACH configurations of data carriers. In step 513, the UE monitors paging occasion and receives paging over the anchor carrier.

The data carrier assignment by the eNB can be sent via paging message or via RRC signaling. The paging message may include data carrier assignment information. The RRC signaling happens in the previous RRC connection (before UE goes to Idle) and asks the UE to perform RACH on the assigned data carrier. The RRC message can be RRC setup, RRC resume, RRC connection reconfiguration, or RRC release message. Upon being paged or receives RRC message in step 513 with data carrier assignment information, in step 514, the UE currently on the anchor carrier switches to the assigned data carrier, and performs RACH procedure and reads PDCCH on the assigned data carrier as indicated by the paging or the RRC signaling.

In step 521, the UE performs RACH procedure by sending a RACH preamble to the eNB. In step 522, the UE receives a random-access response (RAR) message from the eNB. In step 523, the UE sends an RRC establishment request to the eNB. In step 524, the UE receives an RRC reconfiguration message from the eNB. In step 525, the UE sends an RRC reconfiguration complete to the eNB. In step 531, the UE performs data transmission and reception on the data carrier. A timer is started after each data transmission or reception. In step 532, the UE switches back to the anchor carrier upon timeout.

In addition to paging and RRC signaling, data carrier assignment can also be achieved via cross-carrier scheduling. The UE monitors PDCCH on the anchor carrier, and switches to data carrier for data transmission and reception as indicated by the downlink control information (DCI) carried on PDCCH over the anchor carrier. The UE switches back to the anchor carrier right after data transmission or reception indicated by the DCI. For cross-carrier scheduling, since the UE has only one oscillator, RF switching/setting time is needed. That is, there is a non-scheduling period between receiving cross-carrier command on the anchor carrier and receiving data on the data carrier. The non-scheduling period can be implemented by one of the following options: 1) a pre-defined parameter (e.g., one TTI) in specification; 2) a configuration parameter indicated by UE capability; or 3) a variable duration that NB-IOT eNB does not schedule transmission until receiving a valid channel state information (CSI) feedback from the NB-IOT UE.

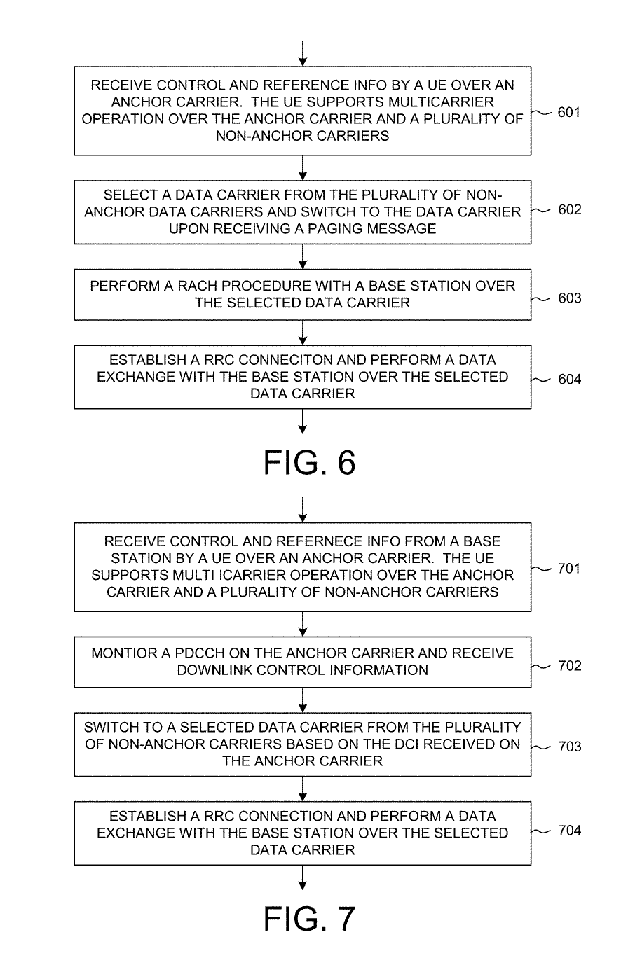

FIG. 6 is a flow chart of a method of multicarrier operation from NB-IOT UE perspective in accordance with one novel aspect. In step 601, a UE receives control and reference information from a base station over an anchor carrier. The UE supports multicarrier operation over the anchor carrier and a plurality of non-anchor carriers. In step 602, the UE selects a data carrier from the plurality of non-anchor carriers and switches to the data carrier upon receiving a paging message. In step 603, the UE performs a random-access channel (RACH) procedure with a base station over the selected data carrier. Finally, in step 604, the UE establishes a radio resource control (RRC) connection and performing a data exchange with the base station over the selected data carrier.

FIG. 7 is a flow chart of a method of multicarrier operation with cross-carrier scheduling in accordance with one novel aspect. In step 701, a UE receives control and reference information from a base station over an anchor carrier. The UE supports multicarrier operation over the anchor carrier and a plurality of non-anchor carriers. In step 702, the UE monitors a physical downlink control channel (PDCCH) on the anchor carrier and receives downlink control information (DCI). In step 703, the UE switches to a selected data carrier from the plurality of non-anchor carriers based on the DCI received on the anchor carrier. In step 704, the UE establishes a radio resource control (RRC) connection and performs a data exchange with the base station over the selected data carrier.

The NB-IOT notation is used in 3GPP, 3^{rd} Generation partnership program, specifications, denoting a system that is part of EUTRA, enhanced universal terrestrial radio access, called Narrowband Internet of things. In the present invention, the notation NB-IOT includes the 3GPP definition, and extends beyond, to all multi-carrier wireless systems. The reason why the NB-IOT notation is used herein is that the benefits of the present invention are most significant in systems where radio resources are scarce, and the traffic is dominated by infrequent data packets in the uplink, which is exactly the case for the 3GPP NB-IOT system. Carrier is a 3GPP notation that is in the present invention extended to include a set of defined radio resources that a UE can use at one point in time, e.g. a single frequency with a bandwidth that the UE is capable to receive, possibly with an additional TDM pattern, or a set of such frequencies with a TDM hopping pattern. In the present invention, a carrier can be either a data carrier, an anchor carrier or both. Data Carrier is a notation introduced in the present invention, which is a carrier where a UE can receive and/or transmit application data. Anchor Carrier is a notation introduced in the present invention, which is a carrier where a UE can camp and receive control and reference information. UE is a 3GPP notation user equipment, that is in the present invention extended to include all sorts of equipments that communicate wirelessly, i.e. any wireless device, also those not intended for human users.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving control and reference information from a base station by a user equipment (UE) over an anchor carrier, wherein the UE supports multicarrier operation over the anchor carrier and a plurality of non-anchor carriers;
selecting a data carrier from the plurality of non-anchor carriers and switching to the data carrier upon receiving a paging message;
performing a random-access channel (RACH) procedure with a base station over the selected data carrier; and
establishing a radio resource control (RRC) connection and performing a data exchange with the base station over the selected data carrier.

2. The method of claim 1, wherein the data carrier is selected autonomously by the UE.

3. The method of claim 2, wherein the data carrier is selected based on the control and reference information received by the UE over the anchor carrier.

4. The method of claim 2, wherein the data carrier is selected based on at least one of a UE identity, a service identity, a network slice identity, a QoS identifier, and a radio coverage of the data carrier.

5. The method of claim 1, wherein the data carrier is selected based on carrier assignment information received from the base station.

6. The method of claim 5, wherein the carrier assignment information is received via the paging message on the anchor carrier.

7. The method of claim 5, wherein the carrier assignment information is received via an RRC signaling on the anchor carrier.

8. The method of claim 1, further comprising:
starting a timer upon completing the data exchange; and
switching back to the anchor carrier when the timer expires.

9. A user equipment (UE) comprising:
a radio frequency (RF) receiver that receives control and reference information from a base station by the UE over an anchor carrier, wherein the UE supports multicarrier operation over the anchor carrier and a plurality of non-anchor carriers;
a carrier selection circuit that selects a data carrier from the plurality of non-anchor carriers and switching to the data carrier upon receiving a paging message;
a random-access circuit that performs a random-access channel (RACH) procedure with a base station over the selected data carrier; and
a radio resource control (RRC) circuit that establishes an RRC connection and performs a data exchange with the base station over the selected data carrier.

10. The UE of claim 9, wherein the data carrier is selected autonomously by the UE.

11. The UE of claim 10, wherein the data carrier is selected based on the control and reference information received by the UE over the anchor carrier.

12. The UE of claim 10, wherein the data carrier is selected based on at least one of a UE identity, a service identity, a network slice identity, a QoS identifier, and a radio coverage of the data carrier.

13. The UE of claim 9, wherein the data carrier is selected based on carrier assignment information received from the base station.

14. The UE of claim 13, wherein the carrier assignment information is received via the paging message on the anchor carrier.

15. The UE of claim 13, wherein the carrier assignment information is received via an RRC signaling on the anchor carrier.

16. The method of claim 1, wherein the UE starts a timer upon completing the data exchange, and the UE switches back to the anchor carrier when the timer expires.

17. A method, comprising:
receiving control and reference information from a base station by a user equipment (UE) over an anchor carrier, wherein the UE supports multicarrier operation over the anchor carrier and a plurality of non-anchor carriers;
monitoring a physical downlink control channel (PDCCH) on the anchor carrier and receiving downlink control information (DCI);
switching to a selected data carrier from the plurality of non-anchor carriers based on the DCI received on the anchor carrier; and
establishing a radio resource control (RRC) connection and performing a data exchange with the base station over the selected data carrier.

18. The method of claim 17, further comprising:
switching back to the anchor carrier when the data exchange is completed.

19. The method of claim 17, further comprising:
switching back to the anchor carrier as indicated by the DCI received on the anchor carrier.

20. The method of claim 17, wherein there is a non-scheduling period between receiving the DCI on the anchor carrier and the data exchange on the selected data carrier.
